(19) United States
(12) Patent Application Publication
(10) Pub. No.: US 2014/0218300 A1
(43) Pub. Date: Aug. 7, 2014

(54) PROJECTION DEVICE

(71) Applicants: Shinjiro Muraki, Tokyo (JP); Yuya Adachi, Tokyo (JP); Kazuhiro Takahashi, Kawasaki-shi (JP); Mami Muratani, Tokyo (JP); Naoto Yamada, Yokohama-shi (JP); Masakazu Sekiguchi, Kawasaki-shi (JP)

(72) Inventors: Shinjiro Muraki, Tokyo (JP); Yuya Adachi, Tokyo (JP); Kazuhiro Takahashi, Kawasaki-shi (JP); Mami Muratani, Tokyo (JP); Naoto Yamada, Yokohama-shi (JP); Masakazu Sekiguchi, Kawasaki-shi (JP)

(73) Assignee: NIKON CORPORATION, Tokyo (JP)

(21) Appl. No.: 13/984,141

(22) PCT Filed: Feb. 9, 2012
(86) PCT No.: PCT/JP2012/052993

§ 371 Date: Nov. 12, 2013

(30) Foreign Application Priority Data
Mar. 4, 2011 (JP) 2011-047746
Mar. 4, 2011 (JP) 2011-047747

(51) Int. Cl. G06F 3/023; G06K 9/00

(52) U.S. Cl. CPC G06F 3/023; G06K 9/00355
USPC 345/168

(57) ABSTRACT

Provided is a user-friendly projection device including: an input unit that inputs an image of a subject person captured by an image capture unit; and a projection unit that projects a first image in accordance with a position of the subject person whose image is captured by the image capture unit.

### TECHNICAL FIELD

The present invention relates to projection devices.

### BACKGROUND ART

There has been conventionally suggested projecting a keyboard on a desk or wall by a projector, analyzing images of fingers operating the keyboard captured by a video camera to carry out an operation, and operating devices with results of the operation (e.g. Patent Document 1).

### PRIOR ART DOCUMENTS

### Patent Documents

Patent Document 1: Japanese Patent Application Publication No. 2000-298544

### SUMMARY OF THE INVENTION

### Problems to be Solved by the Invention

However, the conventional device projects the image of, for example, a key board to a fixed position, and is not always user-friendly.

The present invention has been made in view of the above described problems, and aims to provide a user-friendly projection device.

### Means for Solving the Problems

A projection device of the present invention includes: an input unit that inputs an image of a subject person captured by an image capture unit; and a projection unit that projects a first image in accordance with a position of the subject person whose image is captured by the image capture unit.

In this case, a detection unit that detects information relating to a height of the subject person from the image of the subject person captured by the image capture unit may be included. In this case, the detection unit may detect a height within reach of the subject person.

In addition, the projection device of the present invention may include: a storing unit that stores information relating to a height of the subject person. Moreover, the projection unit may project the first image in accordance with information relating to a height of the subject person.

In addition, in the projection device of the present invention, the projection unit may project the first image in accordance with information relating to a position of the subject person in a horizontal direction. Moreover, the projection unit may project the first image in accordance with a position of a hand of the subject person.

In addition, the projection device of the present invention may include a recognition unit that recognizes that a part of a body of the subject person is located in the first image, wherein the projection unit is able to project a second image so that at least a part of the second image is located at a position different from a position of the first image, and the projection unit changes the at least a part of the second image when the recognition unit recognizes that a part of the body of the subject person is located in the first image.

In this case, the part of the body may be a hand, and the projection unit may change an operation amount relating to at least one of the first image and the second image projected by the projection unit in accordance with a shape of a hand recognized by the recognition unit.

A projection device of the present invention includes: an input unit that inputs an image of a subject person captured by an image capture unit; an acceptance unit that accepts a first gesture performed by the subject person and does not accept a second gesture different from the first gesture in accordance with a position of the subject person whose image is captured by the image capture unit.

In this case, a projection unit that projects an image may be included, and the acceptance unit may accept the first gesture and may not accept the second gesture when the subject person is present at a center part of the image projected. Moreover, a projection unit that projects an image may be included, and the acceptance unit may accept the first gesture and the second gesture when the subject person is present at an edge portion of the image projected.

The projection device of the present invention may include a registration unit capable of registering the first gesture. In this case, a recognition unit that recognizes the subject person may be included, the first gesture to be registered by the registration unit may be registered in association with the subject person, and the acceptance unit may accept the first gesture performed by the subject person and may not accept a second gesture different from the first gesture in accordance with a recognition result of the recognition unit.

In the projection device of the present invention, the acceptance unit may set a time period during which the acceptance unit accepts the first gesture. Moreover, the acceptance unit may end accepting the first gesture when detecting a third gesture different from the first gesture after accepting the first gesture.

In addition, when the projection device of the present invention includes a projection unit that projects an image, the projection unit may change at least a part of the projected image in accordance with the first gesture accepted by the acceptance unit. Moreover, the projection device of the present invention may include a projection unit that projects an image on a screen, and the acceptance unit may accept the second gesture in accordance with a distance between the subject person and the screen.

A projection device of the present invention includes: an input unit that inputs an image of a subject person captured by an image capture unit; a projection unit that projects a first image and a second image; and an acceptance unit that accepts a gesture performed by the subject person in front of the first image distinctively from a gesture performed by the subject person in front of the second image from the image of the subject person captured by the image capture unit, wherein the projection unit projects the first image or second image in accordance with an acceptance result of the acceptance unit.

In this case, the acceptance unit may accept a first gesture and a second gesture different from the first gesture performed by the subject person when the subject person is in front of the first image, and may accept the first gesture and may not accept the second gesture when the subject person is in front of the second image.

A projection device of the present invention includes: a projection unit that projects a first image and a second image different from the first image, each including selection regions; an input unit that inputs an image of a subject person captured by an image capture unit; and an acceptance unit that accepts a gesture performed by the subject person in front of the selection regions of the first image from the image of the subject person captured by the image capture unit and accepts a gesture performed by the subject person in front of regions corresponding to the selection regions of the second image, wherein the projection unit projects the first image or the second image in accordance with an acceptance result of the acceptance unit.

In this case, the acceptance unit may accept a first gesture and a second gesture different from the first gesture performed by the subject person when the subject person is in front of the selection regions of the first image, and may accept the first gesture and may not accept the second gesture performed by the subject person when the subject person is in front of the regions corresponding to the selection regions of the second image.

### Effects of the Invention

The present invention can provide a user-friendly projection device.

### BRIEF DESCRIPTION OF DRAWINGS

FIG. 1 is a diagram illustrating an overview of a projection system in accordance with a first embodiment;

FIG. 2 is a block diagram of the projection system;

FIG. 3 is a diagram illustrating a hardware configuration of a control device in FIG. 2;

FIG. 4 is a functional block diagram of the control device;

FIG. 5 is a diagram illustrating a database used in a process executed by the control unit;

FIG. 6 is a flowchart illustrating a process executed by the control unit;

FIG. 7 is a flowchart illustrating a tangible process at step S14 in FIG. 6;

FIG. 8 is a flowchart illustrating a tangible process at step S20 in FIG. 6;

FIG. 9A is a diagram illustrating a gesture region located on a screen in a second embodiment, and FIG. 9B is a diagram illustrating a correspondence between an imaging element and the gesture region;

FIG. 10 is a diagram illustrating a variation of the second embodiment; and

FIG. 11 is a variation of the first and second embodiments.

### MODES FOR CARRYING OUT THE INVENTION

### First Embodiment

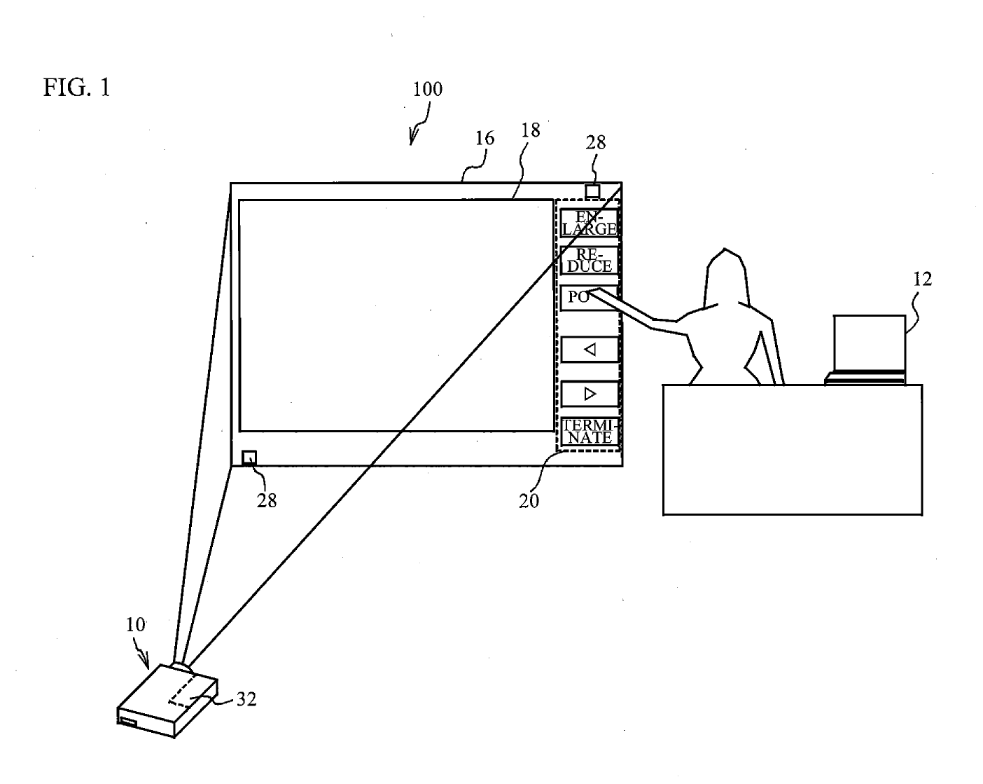

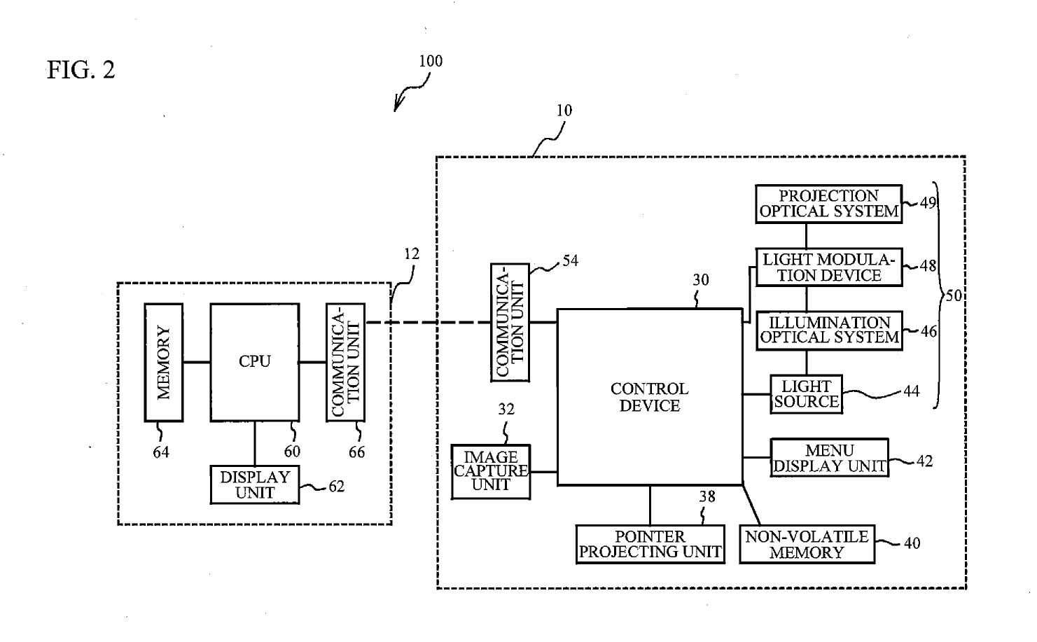

Hereinafter, a detailed description will be given of a first embodiment with reference to FIG. 1 through FIG. 8. FIG. 1 is a diagram illustrating an overview of a projection system 100, and FIG. 2 is a block diagram illustrating a configuration of the projection system 100.

The projection system 100 of the first embodiment is a system that controls images projected on a screen based on a gesture performed by a person who gives a presentation (presenter). As illustrated in FIG. 1, the projection system 100 includes a personal computer 12 (hereinafter, referred to as a PC), an image capture device 32, a screen 16, and a projection device 10.

As illustrated in FIG. 2, the PC 12 includes a CPU (Central Processing Unit) 60, a display unit 62 with a liquid crystal display (LCD: Liquid Crystal Display), a non-volatile memory 64 storing data such as documents for a presentation to be projected on the display unit 62 or the projection device 10, and a communication unit 66 that communicates with the projection device 10. A communication method used in the communication unit 66 may be wireless communication or wired communication. Instead of the PC 12, various information processing devices may be used.

The image capture device 32 includes an imaging lens, a rectangular imaging element such as a CCD (Charge Coupled Device) image sensor or CMOS (Complimentary Metal Oxide Semiconductor) image sensor, and a control circuit that controls the imaging element. The image capture device 32 is installed into the projection device 10, and a non-volatile memory 40 described later stores a positional relationship between the image capture device 32 and a projection unit 50 described later as an apparatus constant.

A wide-angle lens is used for the imaging lens so that the image capture device 32 can capture an image of a region wider than a projection region on which the projection device 10 projects images. In addition, the imaging lens has a focusing lens, and can adjust the position of the focusing lens in accordance with a detection result of a focus detector. The image capture device 32 has a communication function to communicate with the projection device 10, and transmits captured image data to the projection device 10 with the communication function.

In FIG. 1, the image capture device 32 is built into the projection device 10, but may be located near the PC 12. In addition, the image capture device 32 may be connected to the PC 12. In this case, captured image data is transmitted to the PC 12 with the communication function of the image capture device 32, and then transmitted from the PC 12 to the projection device 10. In addition, the image capture device 32 may be separated from the projection device 10, and located near the projection device 10. In this case, the projection system 100 can recognize the positional relationship between the projection device 10 and the image capture device 32 by capturing the image of the region wider than the projection region of the projection device 10, or capturing the images of two marks 28 described later with the image capture device 32.

The first embodiment captures the image of the region wider than the projection region on which the projection device 10 projects images with the wide-angle lens, but does not intend to suggest any limitation. For example, two or more image capture devices 32 may be used to capture the image of the region wider than the projection region.

The screen 16 is a white (or almost white) rectangular shroud located on a wall or the like. As illustrated in FIG. 1, the projection device 10 projects an image (main image) 18 of a presentation material on the screen 16 together with a menu image 20 used when a presenter operates images of the material by gestures. The rectangular marks 28 are located at the upper right corner and lower left corner of the screen 16. The marks 28 are marks that allow the image capture device 32 to visually confirm the size of the screen 16. The mark 28 is a square with 2 cm of sides for example. The image capture device 32 can detect the distance between the image capture device 32 and the screen 16 with pixel output of the imaging element because the focus distance of the imaging lens included in the image capture device 32 and the size of the imaging element are already known. Even when the image capture device 32 is separated from the projection device 10, the distance between the screen 16 and the projection device 10 can be detected when the image capture device 32 and the projection device 10 are located at positions with an identical distance from the screen 16.

The distance between the image capture device 32 and the screen 16 may be detected by capturing the image of a mark projected by the projection device 10 instead of locating the marks 28 on the screen 16. In addition, when the image capture device 32 and the projection device 10 are located at positions with an identical distance from the screen 16, the distance between the screen 16 and the projection device 10 may be detected by capturing the image of a mark projected by the projection device 10. In this case, the non-volatile memory 40 (described later) may store a table containing a relationship between the size of the mark and the distance between the screen 16 and the projection device 10.

The above description presents a case where the distance between the screen 16 and the image capture device 32 or projection device 10 is detected based on the sizes of the marks 28, but does not intend to suggest any limitation, and the distance between the screen 16 and the image capture device 32 or projection device 10 may be detected based on the distance between the two marks 28. Or, the installation position (angle) of the image capture device 32 or projection device 10 with respect to the screen 16 may be detected based on the difference between the sizes or shapes of the two marks 28 in the captured image.

As illustrated in FIG. 2, the projection device 10 includes a control device 30, the projection unit 50, a menu display unit 42, a pointer projection unit 38, the non-volatile memory 40, and a communication unit 54. The communication unit 54 receives image data such as presentation materials from the communication unit 66 of the PC 12.

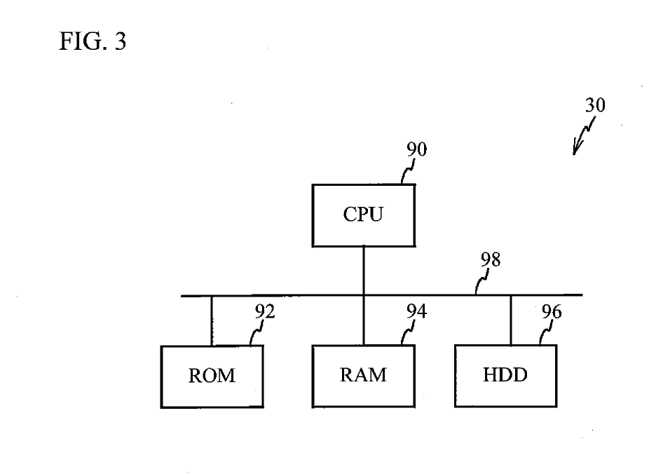

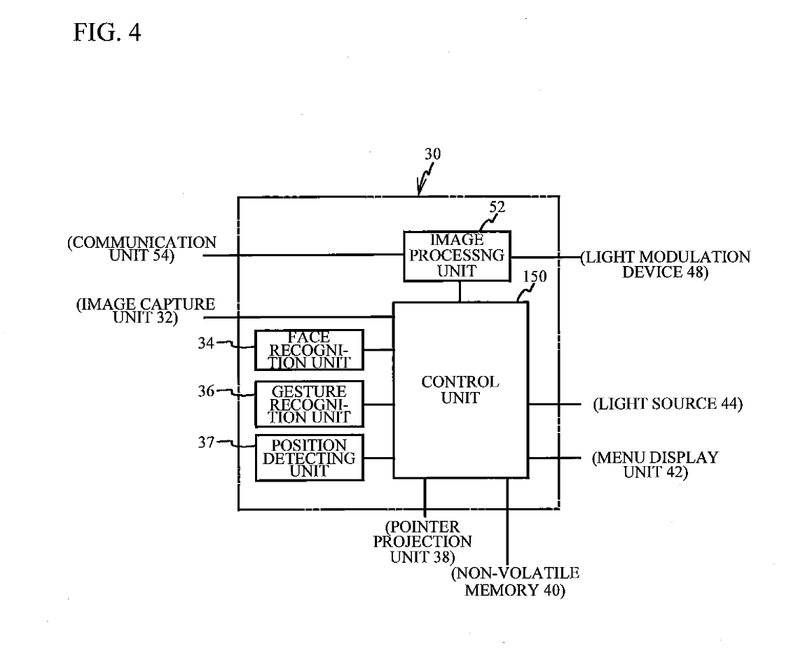

The control device 30 overall controls the whole of the projection device 10. FIG. 3 illustrates a hardware configuration of the control device 30. As illustrated in FIG. 3, the control device 30 includes a CPU 90, a ROM 92, a RAM 94, and a storing unit (here, HDD (Hard Disk Drive)) 96, and the components of the control device 30 are coupled to a bus 98. The control device 30 achieves the function of each unit illustrated in FIG. 4 by executing programs stored in the ROM 92 or HDD 96 by the CPU 90. That is to say, the control device 30 functions as a control unit 150, an image processing unit 52, a face recognition unit 34, a gesture recognition unit 36, and a position detecting unit 37 illustrated in FIG. 4 by executing the programs by the CPU 90.

The control unit 150 overall controls the functions achieved in the control device 30 and the components coupled to the control device 30.

The image processing unit 52 processes image data such as presentation materials and image data captured by the image capture device 32. More specifically, the image processing unit 52 adjusts the image size and contrast of image data, and outputs the image data to a light modulation device 48 of the projection unit 50.

The face recognition unit 34 acquires an image captured by the image capture device 32 from the control unit 150, and detects the face of a presenter from the image. The face recognition unit 34 also recognizes (identifies) the presenter by comparing (pattern matching, for example) the face detected from the image to face data stored in the non-volatile memory 40.

The gesture recognition unit 36 recognizes a gesture performed by the presenter in cooperation with the image capture device 32. In the first embodiment, the gesture recognition unit 36 recognizes a gesture by recognizing that the hand of the presenter is present in front of the menu image 20 for gesture recognition by color recognition (flesh color recognition) in the image captured by the image capture device 32.

The position detecting unit 37 relates the projection region on which the projection unit 50 projects images with the region of which an image is captured by the imaging element of the image capture device 32 to detect the position of the presenter from the image captured by the image capture device 32.

Back to FIG. 2, the projection unit 50 includes a light source 44, an illumination optical system 46, the light modulation device 48, and a projection optical system 49. The light source 44 is a lamp that emits a light beam, for example. The illumination optical system 46 shines the light beam emitted from the light source 44 on the light modulation device 48. The light modulation device 48 is a liquid crystal panel for example, and generates images to be projected on the screen 16 (images based on the image data input from the image processing unit 52). The projection optical system 49 projects the light beam from the light modulation device 48 to the screen 16. The projection optical system 49 includes zoom lenses for adjusting the size of an image to be projected and focus lenses for adjusting the focal position.

The menu display unit 42 displays the menu image 20 for gesture recognition (see FIG. 1) on the screen 16 in accordance with the position of the presenter detected by the position detecting unit 37 based on the image captured by the image capture device 32 under the instruction of the control unit 150. The menu display unit 42 may have a similar configuration to the projection unit 50. That is to say, in the first embodiment, the projection device 10 includes two projection units (the projection unit 50 that projects a main image and the menu display unit 42 that projects a gesture menu), and the positional relationship between the two projection units is also stored in the non-volatile memory 40 as the apparatus constant.

The menu image 20 displayed by the menu display unit 42 includes regions (hereinafter, referred to as selection regions) for enlargement, reduction, illuminating a pointer, paging forward, paging backward, and termination as illustrated in FIG. 1. The gesture recognition unit 36 recognizes that the presenter performs the gesture for paging forward when it detects that the presenter places the hand in front of the selection region for paging forward based on the image captured by the image capture device 32, for example. In addition, the gesture recognition unit 36 recognizes that the presenter performs the gesture for paging forward by three pages when the hand of the presenter in front of the selection region for paging forward presents three fingers. The menu display unit 42 adjusts the position (height position, side position) at which the menu image 20 is to be displayed in accordance with the height and the position of the presenter under the instruction of the control unit 150 before projection onto the screen 16.

The pointer projection unit 38 projects a pointer (e.g. laser pointer) on the screen 16 in accordance with the position of the hand (finger) of the presenter recognized by the gesture recognition unit 36 from the image captured by the image capture device 32 under the instruction of the control unit 150. In the first embodiment, when the presenter places the hand in front of the selection region for illuminating a pointer in the menu image 20 for a given time and then performs a gesture such as drawing a line on the screen 16 with the finger or gesture such as indicating a region (drawing an ellipse) as illustrated in FIG. 1, the pointer projection unit 38 projects (emits) a pointer on a part in which the gesture is performed under the instruction of the control unit 150.

The non-volatile memory 40 includes a flash memory, and stores data (face image data) used in the control by the control unit 150 and data of images captured by the image capture device 32. The non-volatile memory 40 also stores data relating to gestures. More specifically, the non-volatile memory 40 stores data relating to images of right and left hands, and data of images representing numbers with fingers (1, 2, 3 . . . ). The non-volatile memory 40 may store information about the height of a presenter and the range (height) within reach in association with (in connection with) data of the face of the presenter. When the non-volatile memory 40 stores information about the height of a presenter and the range (height) within reach as described above, the control unit 150 can determine the height position at which the menu image 20 is to be displayed based on the information and the recognition result of the face recognition unit 34. In addition, the non-volatile memory 40 or the HDD 96 of the control device 30 may preliminarily store multiple menu images, and the control unit 150 may selectively use a menu image with respect to each presenter based on the recognition result of the face recognition unit 34. In this case, each menu image may be preliminarily related to the corresponding presenter.

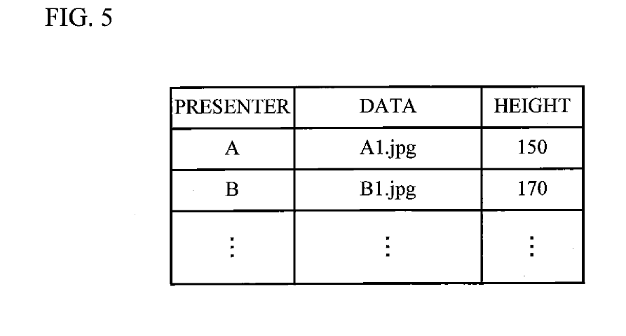

A description will next be given of the operation of the projection system 100 of the first embodiment with reference to FIG. 5 through FIG. 8. In the present embodiment, assume that the non-volatile memory 40 stores a database illustrated in FIG. 5 (database relating presenters to their face data and heights).

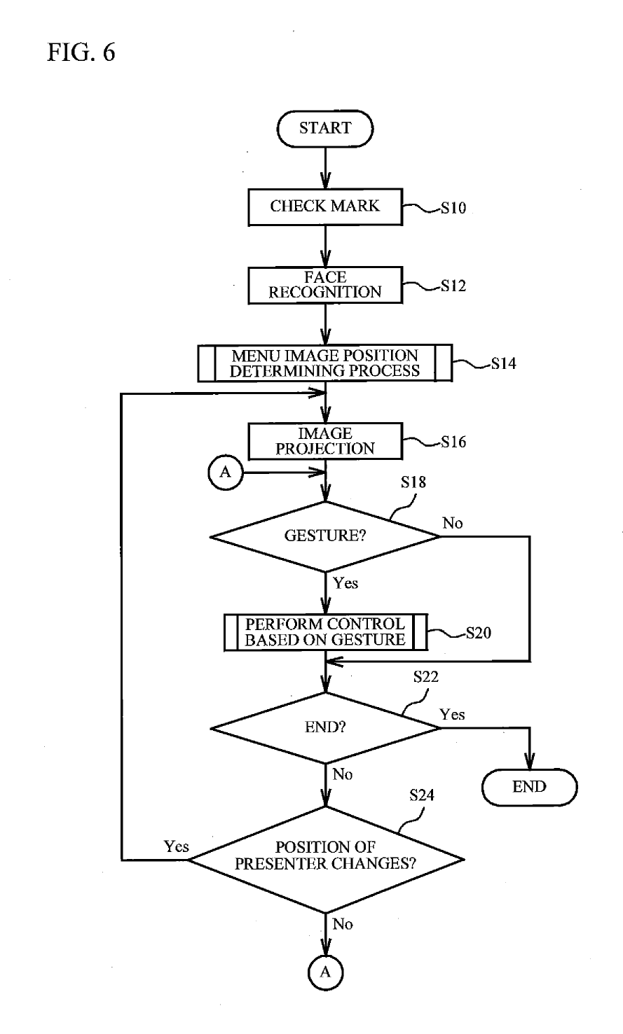

FIG. 6 is a flowchart illustrating a process by the control unit 150 when a presenter gives a presentation with the projection system 100. The PC 12, the projection device 10, the image capture device 32, and the screen 16 are located as illustrated in FIG. 1, and all of them are started before this process is started.

In the process illustrated in FIG. 6, at step S10, the control unit 150 checks the positions of the two marks 28 of which images are captured by the image capture device 32. The control unit 150 determines the positional relationship and distance between the image capture device 32 and the screen 16 and the positional relationship and distance between the projection device 10 and the screen 16 from pixel information of the imaging element that have captured the images of the two marks 28.

Then, at step S12, the control unit 150 instructs the face recognition unit 34 to recognize the face of a presenter from the image captured by the image capture device 32. In this case, the face recognition unit 34 compares (pattern matches) the face in the image to the face data stored in the non-volatile memory 40 (see FIG. 5) to identify the presenter. When the face recognition unit 34 fails to recognize the face of the presenter, that is to say, when the face in the image does not agree with the face data stored in the non-volatile memory 40, it identifies the presenter as an unregistered person.

At step S10 and step S12, the same image captured by the image capture device 32 may be used, or different images may be used. The execution sequence of step S10 and step S12 may be switched.

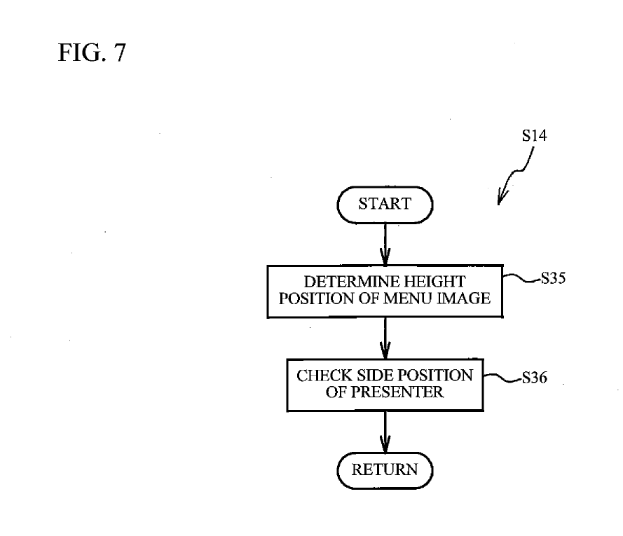

Then, at step S14, the control unit 150 and the like execute a process to determine the position of the menu image 20. More specifically, the process along the flowchart illustrated in FIG. 7 is executed.

In the process of FIG. 7, the control unit 150 determines the height position of the menu image 20 at step S35. Usually, a presenter often stands at the beginning of a presentation. Thus, the control unit 150 can relate the pixel of the imaging element of the image capture device 32 to the position in the height direction by comparing the pixel position at which the image of the face (near the top of the head) is captured to the height stored in the database in FIG. 5. Even when the height information is not stored in the database or the presenter is an unregistered person, since the range within reach is approximately 35 to 55 cm from the top of the head, the control unit 150 thus can determine the height position at which the menu image 20 is to be displayed based on this fact. The necessary height information is not necessarily absolute height information, and may be relative height information between the projection device 10 and the presenter.

The control unit 150 relates coordinates (coordinates (x, y) in the plane of the screen 16) on which the menu image 20 is projected to x and y pixels in the imaging element from the pixels of the imaging element that capture the images of the marks 28 at step S35. This allows the gesture recognition unit 36 to determine in front of which selection region of the menu image 20 the presenter performs a gesture on the basis of the pixel of the imaging element that captures the image of the hand of the presenter.

At step S36, the control unit 150 then checks the side position of the presenter as viewed from the projection device 10. In this case, the control unit 150 determines at which side (right or left) of the screen 16 the presenter is present based on the detection result of the position of the presenter by the position detecting unit 37. When the process illustrated in FIG. 5 is ended as described above, the process moves to step S16 in FIG. 6.

At step S16 in FIG. 6, the control unit 150 controls the image processing unit 52 and the light source 44 to project the main image 18 generated from image data transmitted from the PC 12 on the screen 16 through the projection unit 50. In addition, the control unit 150 controls the menu display unit 42 to project the menu image 20 on the screen 16. In this case, the menu display unit 42 projects the menu image 20 at the height position determined at step S14 and the side closer to the presenter in the side position of the screen 16. The control unit 150 may adjust the projection magnification and focus position of the projection optical system 49 and the projection magnification and focus position of the projection optical system included in the menu display unit 42 in accordance with the distance information acquired at step S10.

At step S18, the control unit 150 determines whether a gesture motion is performed based on the image captured by the image capture device 32. More specifically, the control unit 150 determines that a gesture motion is performed when the hand of the presenter is in front of the menu image 20 projected on the screen 16 for a given time (e.g. 1 to 3 seconds) as illustrated in FIG. 1. As described above, the control unit 150 detects the position of the hand of the presenter to determine a gesture motion, and thus can determine that the action of the presenter is not a gesture motion when the body of the presenter is in front of the menu image 20 for example, and the accuracy of gesture recognition can be improved. When the presenter is at the left side of the screen 16 as viewed from the projection device 10, the left hand may be used to perform a gesture motion to the menu image 20 (the operation with the right hand may cause the right hand to be blocked by his/her own body), and when the presenter is at the right side of the screen 16 as viewed from the projection device 10, the right hand may be used to perform a gesture motion to the menu image 20 (the operation with the left hand may cause the left hand to be blocked by his/her own body). Therefore, the control unit 150 may determine whether a gesture is performed by using an algorithm that preferentially searches the right hand of the presenter when the presenter is at the right side of the screen 16. The process moves to step S20 when the determination of step S18 is Yes, while the process moves to step S22 when the determination of step S18 is No.

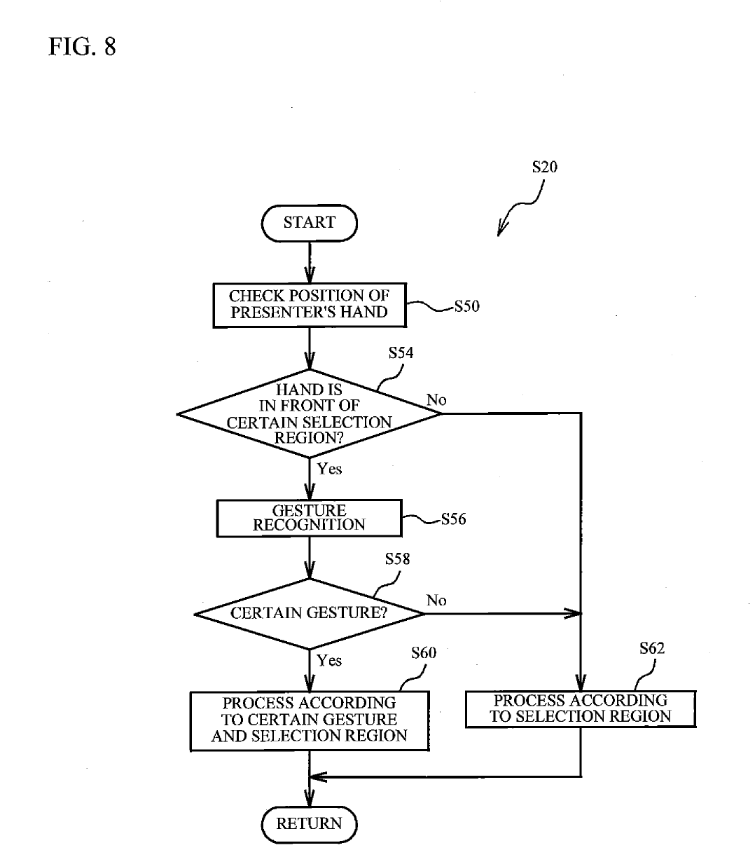

When the determination of step S18 is Yes and the process moves to step S20, the control unit 150 performs a process to control the main image 18 in accordance with a gesture that is performed by the presenter and recognized by the gesture recognition unit 36. More specifically, the control unit 150 executes the process along the flowchart in FIG. 8.

In the process illustrated in FIG. 8, at step S50, the control unit 150 checks the position of the hand of the presenter based on the recognition result of the gesture recognition unit 36. Then, at step S54, the control unit 150 determines whether the hand is positioned in front of a certain selection region. The certain selection region means a selection region that allows special gestures in accordance with the number of fingers presented. For example, the selection regions for “enlargement” and “reduction” allow the presenter to specify the magnification with the number of fingers presented, and thus are the certain selection regions. In addition, the selection regions for “paging forward” and “paging backward” allow the presenter to specify the number of pages to be skipped forward or backward with the number of fingers presented, and thus are the certain selection regions. In contrast, the selection regions for “illuminating a pointer” and “termination” do not allow the special instruction with the number of fingers presented, and thus are not the certain selection regions. The process moves to step S56 when the determination of step S54 is Yes, while the process moves to step S62 when the determination is No.

When the process moves to step S62 because the hand of the presenter is not in front of the certain selection region and the determination of step S56 is No, the control unit 150 performs the process according to the selection region in which the hand of the presenter is positioned. For example, when the hand of the presenter is positioned in the selection region for “illuminating a pointer”, the control unit 150 projects a pointer on the screen 16 through the pointer projection unit 38 as described previously. In addition, when the hand of the presenter is positioned in the selection region for “termination” for example, the control unit 150 ends projecting the main image 18 and the menu image 20 on the screen 16 through the image processing unit 52.

On the other hand, when the determination of step S54 is Yes and the process moves to step S56, the gesture recognition unit 36 recognizes a gesture performed by the presenter under the instruction of the control unit 150. More specifically, the gesture recognition unit 36 recognizes the shape of the hand (the number of fingers presented and the like). In this case, the gesture recognition unit 36 compares (pattern matches) the actual shape of the hand of the presenter to templates of the shapes of hands preliminarily stored in the non-volatile memory 40 (shapes of hands with one finger up, two fingers up, . . . ) to recognize the gesture performed by the presenter.

Then, at step S58, the control unit 150 determines whether the gesture performed by the presenter recognized at step S56 is a certain gesture. Here, assume that the certain gesture is the shape of a hand with two fingers up, three fingers up, four fingers up, or five fingers up, for example. When the determination of step S58 is NO, the process moves to step S62, and the control unit 150 performs the process according to the selection region in which the hand of the presenter is positioned (the process in which the shape of the hand is not taken into account). That is to say, when the hand of the presenter is positioned in the selection region for “paging forward” for example, the control unit 150 sends the instruction to page forward by one page to the CPU 60 of the PC 12 through the communication units 54 and 66. The CPU 60 of the PC 12 transmits the image data of the page corresponding to the instruction from the control unit 150 to the image processing unit 52 through the communication units 66 and 54.

On the other hand, when the determination of step S58 is Yes, the process moves to step S60. At step S60, the control unit 150 performs a process according to the certain gesture and the selection region. More specifically, when the hand of the presenter is positioned in the selection region for “paging forward” and the shape of the hand is a hand with three fingers up, the control unit 150 sends the instruction to page forward by three pages to the CPU 60 of the PC 12 through the communication units 54 and 66. The CPU 60 of the PC 12 transmits the image data of the page corresponding to the instruction from the projection device 10 to the image processing unit 52 through the communication units 66 and 54.

When the process in FIG. 8 is ended as described above, the process moves to step S22 in FIG. 6. At step S22, the control unit 150 determines whether the presentation is ended. The control unit 150 may determine that the presentation is ended when it recognizes the gesture in front of the selection region for “termination” in the menu image 20 described previously, recognizes that the power of the PC 12 is turned OFF, or the image of the presenter can not be captured by the image capture device 32 for a given time. When the determination of step S22 is Yes, the control unit 150 ends the entire process illustrated in FIG. 6. In this case, the control unit 150 notifies the CPU 60 of the PC 12 of the end of the presentation through the communication units 54 and 66.

On the other hand, when the determination of step S22 is No, the process moves to step S24, and the control unit 150 determines whether the position of the presenter changes. The position of the presenter means the side position with respect to the screen 16. When the determination is No, the process moves to step S18. Then, the control unit 150 executes the process from step S18. That is to say, when the hand of the presenter remains in front of the menu screen 20 after the control based on the gesture is performed at previous step S20, the control based on the gesture continues. When the process moves to step S18 after step S20 and the determination of step S18 becomes No, that is to say, when the hand of the presenter is not positioned in front of the menu image 20 after the control of the main image 18 based on the gesture is performed, the control of the main image 18 based on the gesture ends. The control unit 150 may set intervals at which step S18 is performed to a predetermined time (e.g. 0.5 to 1 second) and have intervals between the end of operation by a gesture and the recognition of next operation by a gesture.

When the determination of step S24 is Yes, the process moves to step S16. At step S16, the control unit 150 changes the projection position (displayed position) of the menu image 20 through the menu display unit 42 in accordance with the position of the presenter. After that, the control unit 150 executes the process after step S18 as described previously.

The execution of the process along the flowcharts illustrated in FIG. 6 through FIG. 8 enables to project the menu image 20 in accordance with the position of the presenter, and to operate the main image 18 (change the display) by a gesture when the presenter performs the gesture in front of the menu image 20.

As described above in detail, the first embodiment configures the control unit 150 of the projection device 10 to receive an image of a presenter captured by the image capture device 32, and project the menu image 20 on the screen 16 in accordance with the position of the presenter in the image through the menu display unit 42, and thus can project the menu image 20 at the position that allows the presenter to easily use it (easily perform a gesture). This enables to achieve a user-friendly projection device.

In addition, the present embodiment configures the control unit 150 to detect information relating to the height of the presenter (the height of the presenter or the like) from the image of the presenter and enables to project the menu image 20 at the height position that allows the presenter to easily use it. In this case, the control unit 150 can easily detect (acquire) the information relating to the height of the presenter by registering the height of the presenter in the database in association with the face data of the presenter.

In addition, the present embodiment configures the control unit 150 to detect the height within reach of the presenter (position with a given height from the top of the head), and thus enables to project the menu image 20 in a region within reach of the presenter and improves a degree of usability.

In addition, the present embodiment configures the non-volatile memory 40 to store information relating to the height of the presenter (height or the like), and thus can relate the pixel of the imaging element of the image capture device 32 to the position in the height direction by comparing the height to the pixel of the imaging element of the image capture device 32. This enables to easily determine the projection position of the menu image 20.

In addition, the present embodiment configures the control unit 150 to project the menu image 20 on the screen 16 in accordance with the side position of the presenter with respect to the screen 16 through the menu display unit 42, and thus allows the presenter to easily perform a gesture in front of the menu image 20.

In addition, the present embodiment configures the control unit 150 to change at least a part of the main image 18 through the projection unit 50 when the gesture recognition unit 36 recognizes that the hand of the presenter is positioned in the menu image 20, and thus allows the presenter to operate the main image 18 by only positioning the hand in front of the menu image 20.

In addition, the present embodiment configures the control unit 150 to change the amount with which the main image 18 projected by the projection device 10 is to be operated in accordance with the shape of the hand of the presenter recognized by the gesture recognition unit 36, and thus can easily change a magnification of enlargement or reduction, or the number of pages to be skipped forward or backward.

The above first embodiment may preliminarily provide a margin on which the menu image 20 is projected at the left side of the main image 18 on the screen 16 in FIG. 1 (the side at which the presenter is not present in FIG. 1). This configuration eliminates the change of the position of the main image 18 (shift in the horizontal direction) when the position of the menu image 20 is changed (second and subsequent steps S16 are performed).

The above first embodiment changes the projection position of the menu image 20 whenever the presenter changes the side position to the screen 16, but does not intend to suggest any limitation. That is to say, the projection position may be fixed once the menu image 20 is projected. However, when the projection position of the menu image 20 is fixed, the operation by a gesture may become difficult if the presenter changes the position. A second embodiment described hereinafter addresses this problem.

### Second Embodiment

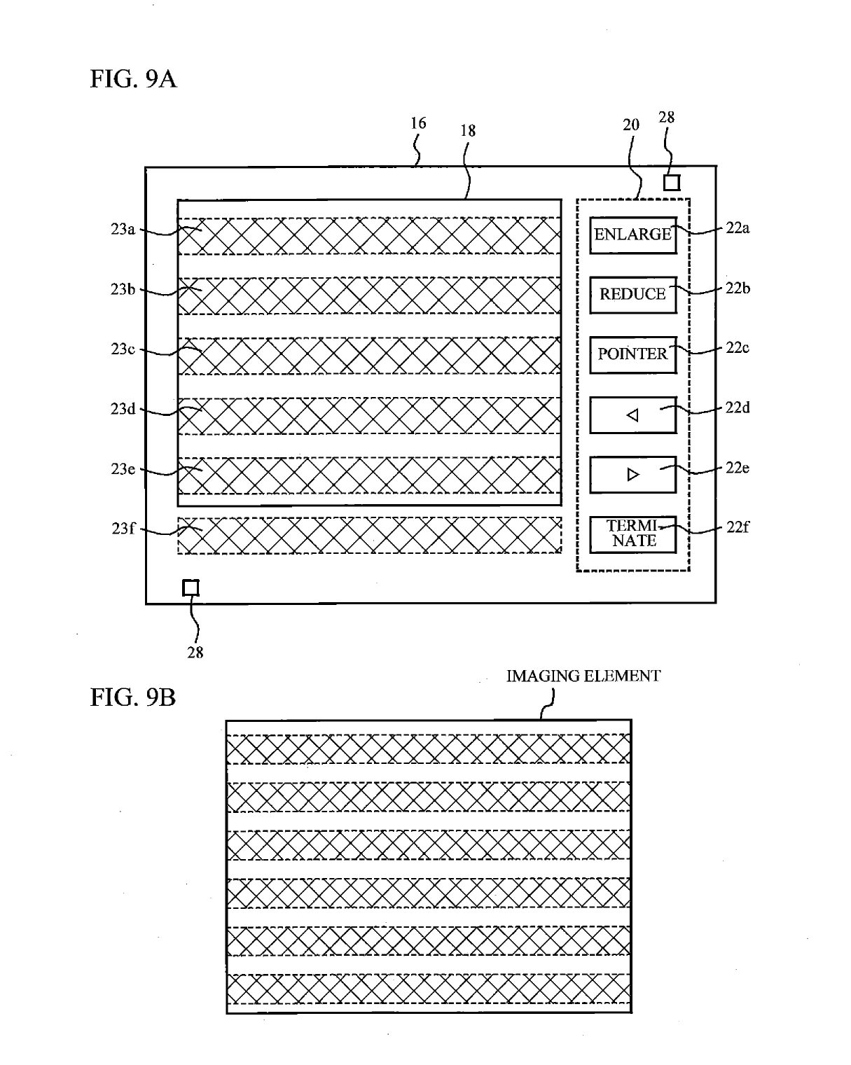

A description will next be given of the second embodiment with reference to FIG. 9A and FIG. 9B. The second embodiment has the same or similar device configuration as or to the first embodiment. Therefore, the description thereof is omitted.

The previously described first embodiment limits the area in which the presenter can perform a gesture to the front of the selection regions of the menu image 20, but the second embodiment makes the region in which a gesture can be performed larger than that of the first embodiment.

More specifically, as illustrated in FIG. 9A, regions extending in a lateral direction at the same heights as selection regions 22a through 22f included in the menu image 20 (regions double-hatched in FIG. 9A) are newly set as regions in which a gesture can be performed (gesture regions 23a through 23f) in a state that the main image 18 and the menu image 20 are being displayed on the screen 16. Spaces (buffering parts) are located between the gesture regions 23a through 23f.

That is to say, in FIG. 9A, the selection region 22a is a region that allows an “enlargement” operation, and the gesture region 23a is also a region that allows the “enlargement” operation. In addition, the selection region 22b is a region that allows a “reduction” operation, and the gesture region 23b is also a region that allows the “reduction” operation. In the same manner, the gesture region 23c is a region that allows an “illuminating a pointer” operation, the gesture region 23d is a region that allows a “paging forward” operation, the gesture region 23e is a region that allows a “paging backward” operation, and the gesture region 23f is a region that allows a “termination” operation.

The gesture regions 23a through 23f are projected with translucent lines visible by the presenter so that they are sandwiched in the height direction of the two marks 28. In this case, the line indicating the boundary between the gesture regions may be projected with a translucent line. The control unit 150 relates the gesture regions 23a through 23f to the image regions of the imaging element of the image capture device 32 as illustrated in FIG. 9B when confirming the two marks 28 at step S10 in FIG. 6. However, when the gesture regions 23a through 23f are actually projected on the screen 16, the height information of the presenter (height or the like) acquired at step S12 is taken into account.

When the gesture regions are provided as described above, it is necessary to determine whether the presenter performs a gesture motion, or simply points at a part to be noticed on the screen 16.

Thus, the second embodiment preliminarily arranges that pointing at the gesture regions 23a through 23f with an index finger represents a gesture motion, and that five fingers (the whole of the hand) are used to point at the part to be noticed of the main image 18, for example. On the other hand, the projection device 10 registers the image data of a hand with one finger up in the non-volatile memory 40 in association with an operation (gesture motion). Then, the gesture recognition unit 36 recognizes a gesture in front of the menu image 20 (selection regions 22a through 221) in the same manner as the first embodiment under the instruction of the control unit 150 when determining that the presenter is present near the menu image 20 (edge portion of the screen) from the detection result of the position detecting unit 37. That is to say, when the presenter is present near the menu image 20, the gesture recognition unit 36 recognizes a motion as a gesture regardless of the number of fingers presented of the hand of the presenter.

On the other hand, the gesture recognition unit 36 recognizes a gesture by comparing (pattern matching) the image of the hand to the registered image data (image data of a hand with one finger up) under the instruction of the control unit 150 when determining that the presenter is away from the menu image 20 (at a position away from the menu image 20 such as the center of the screen) from the detection result of the position detecting unit 37. That is to say, the gesture recognition unit 36 does not recognize a motion as a gesture when the presenter points at the gesture regions 23a through 23f with five fingers (does not agree with the image data registered in the non-volatile memory 40), while it recognizes a motion as a gesture when the presenter points at the gesture regions 23a through 23f with one finger (agree with the image data registered in the non-volatile memory 40). This enables to distinguish a gesture from an action to point at a part to be noticed when the presenter is away from the menu image 20. The non-volatile memory 40 may register images of hands with two fingers up, three fingers up, and four fingers up in association with the amounts to be operated in addition to the image of a hand with one finger up. This allows the control unit 150 to enlarge the main image 18 by a magnification of three times when the presenter points at the gesture region 23a with three fingers.

As described above, the second embodiment allows the presenter to easily perform the operation by a gesture regardless of his/her standing position by providing the gesture regions 23a through 23f even when the control unit 150 does not move the menu image 20 once fixing its projection position. This eliminates the need for the presenter to go back to the position of the menu image 20 and perform a gesture, and thus can increase a degree of usability for the presenter.

In addition, the second embodiment configures the control unit 150 to accept a gesture (use the gesture for control) if the gesture is registered in the non-volatile memory 40 (pointing gesture with one finger) and not to accept a gesture (not to use the gesture for control) if the gesture is not registered in the non-volatile memory 40 (pointing gesture with five fingers) when it can be determined that the presenter is away from the menu image based on the image captured by the image capture device 32. This allows the control unit 150 to distinguish a case where the presenter merely points at a part to be noticed of the main image 18 from a case where he/she performs a gesture in front of the gesture regions 23a through 23f even when the gesture regions 23a through 23f are provided on the main image 18. This enables to appropriately reflect the user's gesture to the operation of the main image 18. Therefore, a degree of usability for the presenter can be improved.

The above second embodiment registers the image data of a hand (e.g. hand with one finger up) in the non-volatile memory 40 in association with an operation (gesture motion), that is to say, requires any presenter to perform preliminarily determined common gestures, but does not intend to suggest any limitation. That is to say, the image data of a hand may be registered in the non-volatile memory 40 with respect to each presenter. This can increase a degree of usability for each presenter. When registered in the non-volatile memory 40, the image data of the hands may be registered in association with the face images in the database illustrated in FIG. 5 for example.

The above embodiment projects the gesture regions 23a through 23f with translucent lines, but does not intend to suggest any limitation, and may not display (project) the gesture regions 23a through 23f on the screen 16. In this case, the presenter may estimate the gesture region from the position of the selection region of the menu image 20.

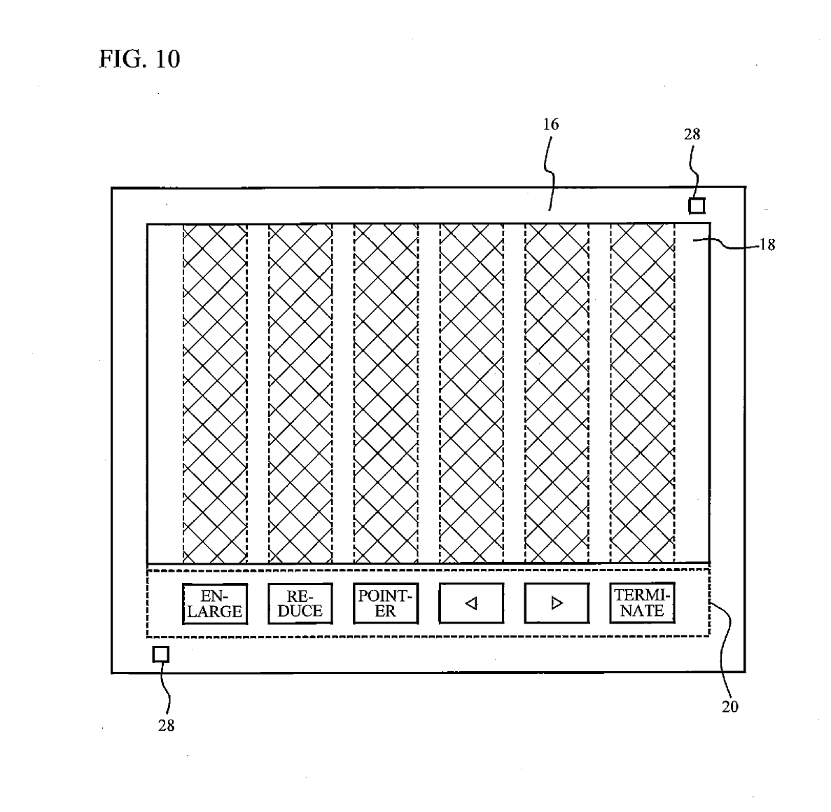

The above second embodiment arranges the menu image 20 at the edge portion of the screen 16 in the horizontal direction, but does not intend to suggest any limitation. For example, as illustrated in FIG. 10, the menu image 20 may be located near the lower edge portion of the screen 16. Even in this case, the coordinates of the pixel of the imaging element can be related to the coordinates (x and y coordinates) in the plane of the screen 16 from the positions of the marks 28 checked at step S10 (FIG. 6).

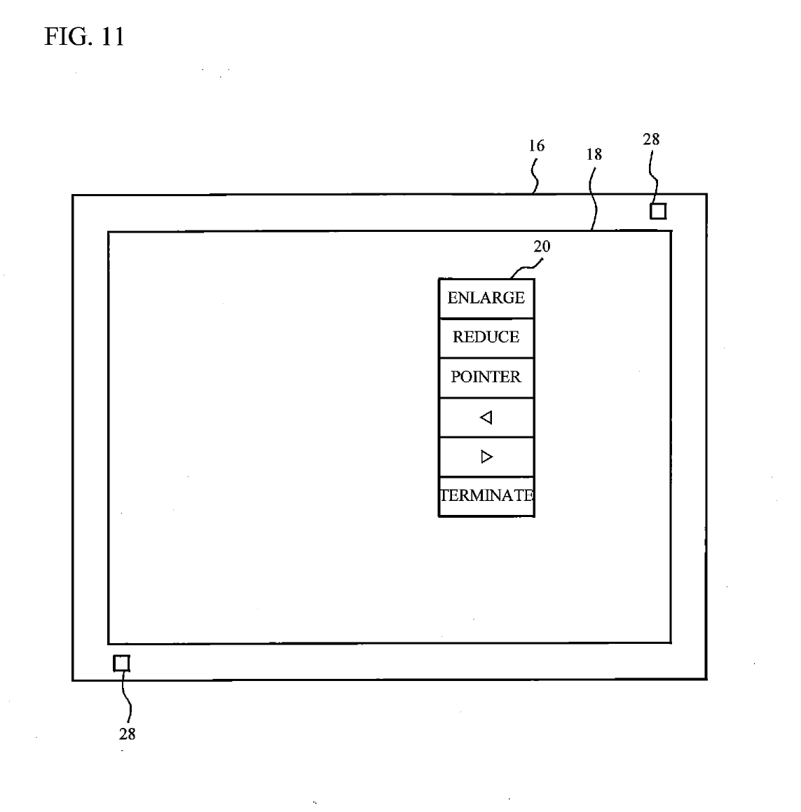

The above first and second embodiments project the menu image 20 and the main image 18 at different positions, but do not intend to suggest any limitation, and may project them so that the menu image 20 overlaps a part of the main image 18 as illustrated in FIG. 11. In this case, when the presenter places the hand in front of the main image 18 and the gesture recognition unit 36 recognizes that the presenter performs the certain gesture for example, the control unit 150 may display a menu image 70 near the hand of the presenter through the menu display unit 42. This enables to display (project) the menu image 70 at the position within reach of the presenter, and thus a high degree of usability for the presenter is achieved. In addition, the setting of the menu image 70 may be configured from the PC 12, or by the communication between the PC 12 and the projection device 10. More specifically, the possible menu images 20 may be transmitted from the projection device 10 to the PC 12, and the menu image may be selected in the PC 12.

In the first and second embodiments, when the gesture recognition unit 36 recognizes that the presenter points at the selection region for “illuminating a pointer” with the index finger, the control unit 150 may determine that a gesture motion for illuminating a pointer is performed, and then continue illuminating a laser pointer at the position indicated by the hand of the presenter from the pointer projection unit 38. In this case, the trajectory of the hand can be detected by well-known techniques.

A period during which the gesture recognition unit 36 handles a gesture motion (moving of fingers) as effective (period till illuminating a pointer is terminated) may be set to a time (e.g. 5 through 15 seconds). Setting the period during which the gesture motion is effective allows the presenter to appropriately display a laser pointer by only performing a gesture in front of “illuminating a pointer” and moving the finger within the effective period. When the period during which a gesture motion is effective is set to a time, the time may be a given uniform time (e.g. about 10 seconds), or may be set with respect to each presenter at a time when each presenter is registered in the non-volatile memory 40. The control unit 150 may end illuminating a pointer with the pointer projection unit 38 when the gesture recognition unit 36 recognizes that the presenter performs a gesture indicating the end of the gesture motion (moving of fingers) (e.g. turns his/her palm toward the image capture device 32). This configuration allows the presenter to display a laser pointer as necessary.

Instead, a touch panel function may be added to the screen 16, and a laser pointer may be emitted with the touch panel function (e.g. by touching the screen 16) after the presenter selects the region for “illuminating a pointer”. In this case, a laser pointer may be emitted by the continuous operation of the touch panel, or a laser pointer may be emitted from the pointer projection unit 38 by specifying a starting point and an end point through the touch panel. When a touch panel is installed into the screen 16, an action may be determined as an action calling attention if a gesture motion is performed as described in the second embodiment and the touch panel is activated (e.g. the screen 16 is touched), while an action may be determined as a gesture motion if a gesture motion is performed and the presenter is away from the screen 16 so as not to activate the touch panel (e.g. not to touch the screen 16). As described above, a touch panel may be installed into the screen 16, and a gesture motion and an action calling attention may be distinguished from each other in accordance with the distance between the screen 16 and the presenter.

A touch panel may be arbitrarily selected from a resistive touch panel, a surface acoustic wave touch panel, an infrared touch panel, an electromagnetic touch panel, and a capacitive touch panel.

The above embodiments configure the PC 12 to be able to communicate with the projection device 10 and configure the PC 12 to send the material data to the projection device 10, but do not intend to suggest any limitation, and may employ a digital camera instead of the PC 12. In this case, images captured by the digital camera can be displayed on the screen 16. The digital camera has an image capturing function and a face recognition function, and thus these functions may substitute the image capture device 32 in FIG. 2 and the face recognition unit 34 in FIG. 4, and the image capture device 32 in FIG. 2 and the face recognition unit 34 in FIG. 4 may be omitted.

In the above embodiments, the presenter operates the main image 18 by performing a gesture in front of the menu image 20, but may operate the menu image 20 itself by a gesture in front of the menu image 20 instead. The operation of the menu image 20 includes operations for enlarging, reducing, moving, and closing the menu image 20.

The above embodiments arrange the rectangular marks 28 at the lower left and the upper right of the screen 16, but do not intend to suggest any limitation. The locations and the number of marks 28 are selectable, and the shapes of the marks 28 may be various shapes such as circles or diamond shapes.

The above embodiments provide the menu display unit 42 separately from the projection unit 50, but do not intend to suggest any limitation. For example, the projection unit 50 may project both the main image 18 and the menu image 20 on the screen 16. In this case, the CPU 60 of the PC 12 is configured so as to synthesize the main image and the menu image and transmit it to the image processing unit 52 through the communication units 66 and 54. In this case, the position of the presenter (height position, side position) is transmitted to the CPU 60 of the PC 12 from the projection device 10 side, and the CPU 60 adjusts the position of the menu image in accordance with the position of the presenter.

Any type of projection device may be used for the projection device 10 (projection unit 50), and the installation location may be arbitrarily determined. For example, the projection device 10 (projection unit 50) may be located on a ceiling or wall, and perform the projection from above the screen 16. In addition, when the screen 16 is large, the projection with multiple projection devices 10 (projection units 50) may be performed.

The above embodiments only describe exemplary configurations. For example, the configuration in FIG. 2 and the functional block diagram in FIG. 4 are exemplary examples, and various modifications are possible. For example, in FIG. 4, the face recognition unit 34, the gesture recognition unit 36, the position detecting unit 37, and the image processing unit 52 are described as a part of functions of the control device 30, but these functions may be achieved by hardware devices instead. In this case, each unit are achieved by separate CPUs and the like.

While the exemplary embodiments of the present invention have been illustrated in detail, the present invention is not limited to the above-mentioned embodiments, and other embodiments, variations and modifications may be made without departing from the scope of the present invention.

1. A projection device comprising:
an input unit configured to input an image of a person captured by an image capture unit; and
a projector configured to project a first image in accordance with a position of the person whose image is captured by the image capture unit.

2. The projection device according to claim 1, further comprising:
a detector configured to detect information relating to a height of the person from the image of the person captured by the image capture unit.

3. The projection device according to claim 2, wherein
the detector detects a height within reach of the person.

4. The projection device according to claim 1, further comprising:
a memory configured to memorize information relating to a height of the person.

5. The projection device according to claim 1, wherein
the projector projects the first image in accordance with information relating to a height of the person.

6. The projection device according to claim 1, wherein
the projector projects the first image in accordance with information relating to a position of the person in a horizontal direction.

7. The projection device according to claim 1, wherein
the projector projects the first image in accordance with a position of a hand of the person.

8. The projection device according to claim 1, further comprising:
a recognition unit configured to recognize that a part of a body of the person is located in the first image, wherein
the projector is able to project a second image so that at least a part of the second image is located at a position different from a position of the first image, and
the projector changes the at least a part of the second image when the recognition unit recognizes that a part of the body of the person is located in the first image.

9. The projection device according to claim 8, wherein
the part of the body is a hand, and
the projector changes an operation amount relating to at least one of the first image and the second image projected by the projector in accordance with a shape of the hand recognized by the recognition unit.

10. A projection device comprising:
an input unit configured to input an image of a person captured by an image capture unit;
an acceptance unit configured to accept a first gesture performed by the person and refuse a second gesture different from the first gesture in accordance with a position of the person whose image is captured by the image capture unit.

11. The projection device according to claim 10, further comprising:
a projector configured to project an image, wherein
the acceptance unit accepts the first gesture and refuses the second gesture when the person is present in a center part of the image projected.

12. The projection device according to claim 10, further comprising:
a projector configured to project an image, wherein
the acceptance unit accepts the first gesture and the second gesture when the person is present at an edge portion of the image projected.

13. The projection device according to claim 10, further comprising:
a register capable of registering the first gesture.

14. The projection device according to claim 13, further comprising:
a recognition unit configured to recognize the person, wherein
the first gesture to be registered by the register is registered in association with the person, and
the acceptance unit accepts the first gesture performed by the person and refuses the second gesture different from the first gesture in accordance with a recognition result of the recognition unit.

15. The projection device according to claim 10, wherein
the acceptance unit sets a time period during which the acceptance unit accepts the first gesture.

16. The projection device according to claim 10, wherein
the acceptance unit ends accepting the first gesture when detecting a third gesture different from the first gesture after accepting the first gesture.

17. The projection device according to claim 11, wherein
the projector changes at least a part of the projected image in accordance with the first gesture accepted by the acceptance unit.

18. The projection device according to claim 10, further comprising:
a projector configured to project an image on a screen, wherein
the acceptance unit accepts the second gesture in accordance with a distance between the person and the screen.

19. A projection device comprising:
an input unit configured to input an image of a person captured by an image capture unit;
a projector configured to project a first image and a second image; and
an acceptance unit configured to accept a gesture performed by the person in front of the first image distinctively from a gesture performed by the person in front of the second image from the image of the person captured by the image capture unit, wherein
the projector projects the first image or second image in accordance with an acceptance result of the acceptance unit.

20. A projection device according to claim 19, wherein
the acceptance unit accepts a first gesture and a second gesture different from the first gesture performed by the person when the person is in front of the first image, and accepts the first gesture and refuses the second gesture when the person is in front of the second image.

21. A projection device comprising:
a projector configured to project a first image and a second image, the second image being different from the first image, and each of the first image and the second image including selection regions;
an input unit configured to input an image of a person captured by an image capture unit; and
an acceptance unit configured to accept a gesture performed by the person in front of the selection regions of the first image and accept a gesture performed by the person in front of regions corresponding to the selection regions of the second image from the image of the person captured by the image capture unit, wherein
the projector projects the first image or the second image in accordance with an acceptance result of the acceptance unit.

22. The projection device according to claim 21, wherein
the acceptance unit accepts a first gesture and a second gesture different from the first gesture performed by the person when the person is in front of the selection regions of the first image, and accepts the first gesture and refuse the second gesture performed by the person when the person is in front of the regions corresponding to the selection regions of the second image.
